(19) United States
(12) Patent Application Publication
(10) Pub. No.: US 2018/0174141 A1
(43) Pub. Date: Jun. 21, 2018

(54) METHOD AND SYSTEM FOR LEVERAGING ACTIVE AUTHENTICATION FOR THIRD PARTY COMMUNICATIONS

(71) Applicant: Mastercard International Incorporated, Purchase, NY (US)

(72) Inventors: Oran CUMMINS, Dublin (IE); Saravana Perumal SHANMUGAM, Fremont, CA (US); Adam Kenneth HOSP, Lake St. Louis, MO (US); Brad COSSAR, Croydon Hills (AU); Michael MINELLI, Pleasantville, NY (US); Cassio Dias CASSIMINHO, Dublin (IE); Kevin QUEENEY, Dublin (IE); Luiz Gustavo PAGANI, Dublin (IE)

(73) Assignee: Mastercard International Incorporated, Purchase, NY (US)

(21) Appl. No.: 15/384,923

(22) Filed: Dec. 20, 2016

(51) Int. Cl. G06Q 20/40

(52) U.S. Cl. CPC G06Q 20/40

(57) ABSTRACT

A method for supplying payment credentials in a secondary payment opportunity includes: receiving a first data signal from a first computing device superimposed with at least payment credentials associated with a transaction account; electronically transmitting a second data signal to a second computing device superimposed with a payment opportunity request; receiving a third data signal from the second computing device superimposed with at least one payment opportunity; electronically transmitting a fourth data signal superimposed with the at least one payment opportunity; receiving a fifth data signal superimposed with an indication of one of the at least one payment opportunity; and electronically transmitting a sixth data signal to the second computing device superimposed with at least the indicated payment opportunity and the payment credentials.

### FIELD

The present disclosure relates to the supplying of payment credentials in a secondary payment opportunity, specifically the leveraging of an active authentication session with a first merchant system for use in secondary payment opportunities with additional merchant systems.

### BACKGROUND

In many cases, the processing of a payment transaction involves the authentication of the payment credentials presented that are associated with a transaction account used to fund the payment transaction. Such authentication is often performed to protect the owner of the transaction account, the issuer of the transaction account, as well as the merchant involved in the payment transaction. As a result, in many cases payment transactions may not be conducted without proper authentication.

However, authentication can sometimes be a time-consuming task, particularly in e-commerce or other payment transactions conducted using a computing device. In such transactions, a user of the computing device may be required to enter a significant amount of data as a manner of authenticating their payment credentials, such as the entry of a transaction account number, expiration date, security code, account holder name, registered account address, etc. Such a volume of information may take a significant amount of time, which may deter a consumer from engaging in transactions they may participate in otherwise.

Thus, there is a need for a technical solution to enable the use of previously authenticated payment credentials in a secondary payment opportunity, without the need for additional authentication, thereby simplifying and speeding up user interaction with the user's computing device.

### SUMMARY

The present disclosure provides a description of systems and methods for the supplying of payment credentials in a secondary payment opportunity. Such systems and methods may provide for a technological solution that enables the carrying out of a secondary payment opportunity that is funded with a transaction account using payment credentials without authentication, due to previous authentication of the payment credentials in an initial payment opportunity. As a result, the second payment transaction may be conducted more quickly and with greater convenience for the consumer, which may also result in a transaction for the secondary merchant that may not be conducted otherwise.

A method for supplying payment credentials in a secondary payment opportunity includes: receiving, by a receiving device of a processing server, a first data signal from a first computing device superimposed with at least payment credentials associated with a transaction account; electronically transmitting, by a transmitting device of the processing server, a second data signal to a second computing device superimposed with a payment opportunity request; receiving, by the receiving device of the processing server, a third data signal from the second computing device superimposed with at least one payment opportunity; electronically transmitting, by the transmitting device of the processing server, a fourth data signal superimposed with the at least one payment opportunity; receiving, by the receiving device of the processing server, a fifth data signal superimposed with an indication of one of the at least one payment opportunity; and electronically transmitting, by the transmitting device of the processing server, a sixth data signal to the second computing device superimposed with at least the indicated payment opportunity and the payment credentials.

A system for supplying payment credentials in a secondary payment opportunity includes: a receiving device of a processing server configured to receive a first data signal from a first computing device superimposed with at least payment credentials associated with a transaction account; and a transmitting device of the processing server configured to electronically transmit a second data signal to a second computing device superimposed with a payment opportunity request, wherein the receiving device of the processing server is further configured to receive a third data signal from the second computing device superimposed with at least one payment opportunity, the transmitting device of the processing server is further configured to electronically transmit a fourth data signal superimposed with the at least one payment opportunity, the receiving device of the processing server is further configured to receive a fifth data signal superimposed with an indication of one of the at least one payment opportunity, and the transmitting device of the processing server is further configured to electronically transmit a sixth data signal to the second computing device superimposed with at least the indicated payment opportunity and the payment credentials.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the supplying of payment credentials in a secondary payment opportunity in accordance with exemplary embodiments.

FIG. 2 is a block diagram illustrating a processing server for supplying payment credentials in a secondary payment opportunity for use in the system of FIG. 1 in accordance with exemplary embodiments.

FIGS. 3A and 3B are a flow diagram illustrating a process for the supplying of payment credentials in a secondary payment opportunity via a first merchant system using the system of FIG. 1 in accordance with exemplary embodiments.

FIGS. 4A-4C are a flow diagram illustrating a process for the supplying of payment credentials in a secondary payment opportunity via an intermediary system using the system of FIG. 1 in accordance with exemplary embodiments.

FIG. 5 is a flow chart illustrating an exemplary method for supplying payment credentials in a secondary payment opportunity in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Leveraged Authentication in a Secondary Payment Opportunity

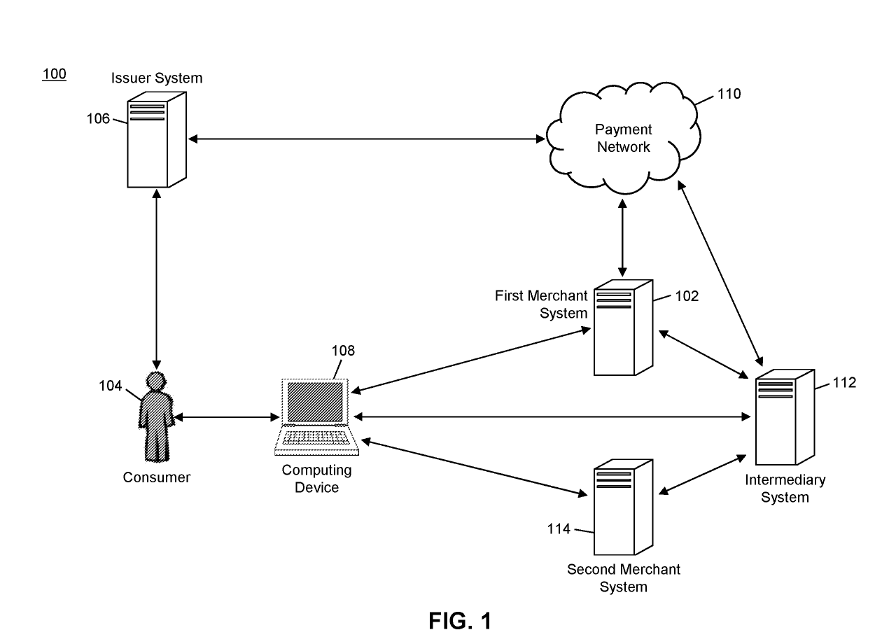

FIG. 1 illustrates a system 100 for the leveraging of previously authenticated payment credentials in a secondary payment opportunity for use therein without having to re-authenticate.

The system 100 may include a first merchant system 102. The first merchant system 102 may include one or more processing servers, such as discussed in more detail below, which may be configured to receive and supply payment credentials for use in a secondary payment opportunity. The first merchant system 102 may be associated with a merchant involved in a payment transaction for which payment credentials may be received from a consumer 104 associated therewith.

In the system 100, the consumer 104 may receive a transaction account from an issuer system 106. The issuer system 106 may be a system associated with a financial institution, such as an issuing bank, or other entity that is configured to issue transaction accounts to consumers 104 for use in funding payment transactions. The issuer system 106 may issue a transaction account to the consumer 104 and, as part of the issuing of the transaction account, may provide the consumer 104 with payment credentials to use in payment transactions conducted via a computing device 108. Such payment credentials may include data suitable for use in a payment transaction, such as a transaction account number, expiration date, and security code. Additional data that may be provided to the consumer 104 as part of the issuing of the transaction account will be apparent to persons having skill in the relevant art.

The consumer 104 may enter the payment credentials for the transaction account into a computing device 108 for electronic transmission to the first merchant system 102 for use in a payment transaction. The computing device 108 may be any type of computing device 108 suitable for performing the functions discussed herein, such as a desktop computer, laptop computer, notebook computer, tablet computer, cellular phone, smart phone, smart watch, smart television, wearable computing device, implantable computing device, etc. The consumer 104 may enter the payment credentials using an input device of the computing device 108. The computing device 108 may then electronically transmit the payment credentials to the first merchant system 102 using a suitable communication network and method. For instance, in one example, the computing device 108 may submit the payment credentials to the first merchant system 102 via a web page associated therewith. In another example, the computing device 108 may execute an application program associated with the first merchant system 102, through which the payment credentials may be input and electronically transmitted.

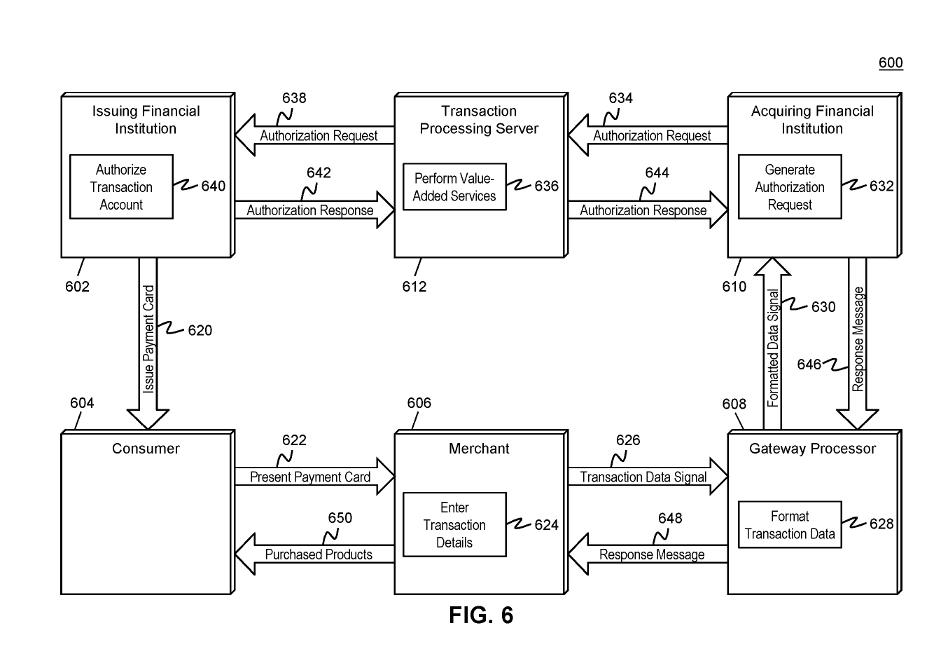

The first merchant system 102 may receive the payment credentials and may use them in a payment transaction. The first merchant system 102 may electronically transmit the payment credentials and other transaction data to a payment network 110 for processing thereof. In some instances, the first merchant system 102 may electronically transmit the transaction data, including the payment credentials, directly to the payment network 110. In other instances, the transaction data may be electronically transmitted through one or more intermediate entities, such as an acquiring institution, gateway processor, or an intermediary system 112, discussed in more detail below. In some embodiments, the transaction data may be included in a transaction message, which may be a specially formatted data message that is formatted pursuant to one or more standards governing the exchange of financial transaction messages, such as the International Organization of Standardization's ISO 8583 or ISO 20022 standards. The payment network 110 may receive the transaction message and may process the payment transaction accordingly using traditional methods and systems, which may include contacting the issuer system 106 for authentication of the payment credentials. Upon successful authentication, the payment transaction may be finalized with the transaction amount being transferred to the first merchant system 102 and the transacted-for goods or services being furnished to the consumer 104. Additional information regarding the processing of a payment transaction is discussed in with respect to the process 600 illustrated in FIG. 6 and discussed in more detail below.

Following the processing of the initial payment transaction, also referred to herein as a “primary” or “original” payment transaction, the consumer 104 may be presented with a secondary payment opportunity with which to use their previously authenticated payment credentials. The secondary payment opportunity may be processed by a second merchant system 114 associated with a merchant involved in the secondary payment opportunity. Details associated with the secondary payment opportunity may be provided by the second merchant system 114. The details may include, for example, the goods or services to be purchased, cost amounts, shipping details, size information, color information, and other data associated with the secondary payment opportunity.

The details of the secondary payment opportunity may be electronically transmitted to the computing device 108 for presentation to the consumer 104. In some embodiments, the secondary payment opportunity may be electronically transmitted directly by the second merchant system 114 to the computing device 108. In other embodiments, the second merchant system 114 may provide the secondary payment opportunity details to the first merchant system 102, which may deliver the details to the computing device 108, such as using the same communication method used for the initial payment transaction. In still other embodiments, an intermediary system 112, discussed in more detail below, may be used.

The consumer 104 may be presented with the secondary payment opportunity on the computing device 108 via a display or other output device thereof. The consumer 104 may then decide to take advantage of the secondary payment opportunity and initiate a secondary payment transaction for the opportunity. The consumer 104 may convey their acceptance using the computing device 108, which may be conveyed to the entity that provided the secondary payment opportunity to the computing device 108. Upon receipt of the acceptance, the first merchant system 102 may receive a notification of the acceptance from the appropriate entity, if applicable. The first merchant system 102 may then convey the payment credentials to the second merchant system 114 using a suitable communication network and method. The second merchant system 114 may initiate a payment transaction using the payment credentials, which may include the transmission of the payment credentials and other transaction data for the secondary payment opportunity to the payment network 110 for processing. In some embodiments, a transaction message associated therewith may include an indication of the prior authentication of the payment credentials.

In some embodiments, the system 100 may include an intermediary system 112. The intermediary system 112 may be a processing server, such as discussed in more detail below, that is configured to identify and handle secondary payment opportunities on behalf of first merchant systems 102. In such embodiments, following the initial payment transaction, the first merchant system 102 may electronically transmit a request for a secondary payment opportunity to the intermediary system 112 using a suitable communication network and method. In some embodiments, the request may include data associated with the initial payment transaction, such as a merchant industry, product industry, product name, and other transaction data that may be used in the identification of secondary payment opportunities. The intermediary system 112 may then contact one or more second merchant systems 114 to request secondary payment opportunities. In instances where transaction data was provided to the intermediary system, the transaction data may be provided to the second merchant systems 114 to use in their identification of the secondary payment opportunities.

The second merchant systems 114 may identify one or more opportunities, which may be electronically transmitted back to the intermediary system 112 using a suitable communication network and method. The intermediary system 112 may then forward the secondary payment opportunities to the first merchant system 102 for forwarding to the computing device 108, or may directly transmit the secondary payment opportunities to the computing device 108. In some instances, the secondary payment opportunities may be filtered, such as based on criteria set by the first merchant system 102 or the consumer 104. Criteria may include, for example, merchant industry preferences, product preferences, transaction amount limits, etc. In such instances, the filtering may be performed by the intermediary system 112 or the first merchant system 102 prior to transmission to the computing device 108.

If the consumer 104 selects a secondary payment opportunity, the intermediary system 112 may be notified by the computing device 108 and, if applicable, the first merchant system 102. In some embodiments, the intermediary system 112 may provide the payment credentials to the second merchant system 114 for use in the secondary payment transaction. In other embodiments, the intermediary system 112 may initiate the secondary payment transaction directly, on behalf of the second merchant system 114. In some cases, the intermediary system 112 may contact the first merchant system 102 for the payment credentials upon acceptance of the secondary payment opportunity by the consumer 104. In other cases, the intermediary system 112 may receive the payment credentials with the initial request for secondary payment opportunities.

In some embodiments, a reference identifier may be used in place of the payment credentials. In such embodiments, the first merchant system 102 may identify a reference identifier to use in place of the payment credentials when communicating with the other entities. For instance, the first merchant system 102 may include the reference identifier in the request for a secondary payment opportunity electronically transmitted to the intermediary system 112 or second merchant system 114, which may also be included in return communications. The first merchant system 102 may be configured to identify payment credentials that are associated with a reference identifier for providing thereof to the payment network 110, intermediary system 112, or second merchant system 114, as applicable. The reference identifier may be any suitable value, such as an identification number, alphanumeric code, etc.

The methods and systems discussed herein may enable the consumer 104 to engage in a secondary payment opportunity without having to present payment credentials a second time. As a result, payment transactions may be conducted with higher convenience and ease of use to the consumer 104, which may also result in payment transactions with second merchant systems 114 that may otherwise not be conducted. Thus, the methods and systems discussed herein may be able to leverage authenticated payment credentials in future payment transactions at the benefit of each of the entities involved. In instances where an intermediary system 112 is also used, such a system may be implemented with minimal modification to existing first merchant systems 102 as well, as the intermediary system 112 may be able to perform all communications with second merchant systems 114 and, if applicable, payment networks 110.

### Processing Server

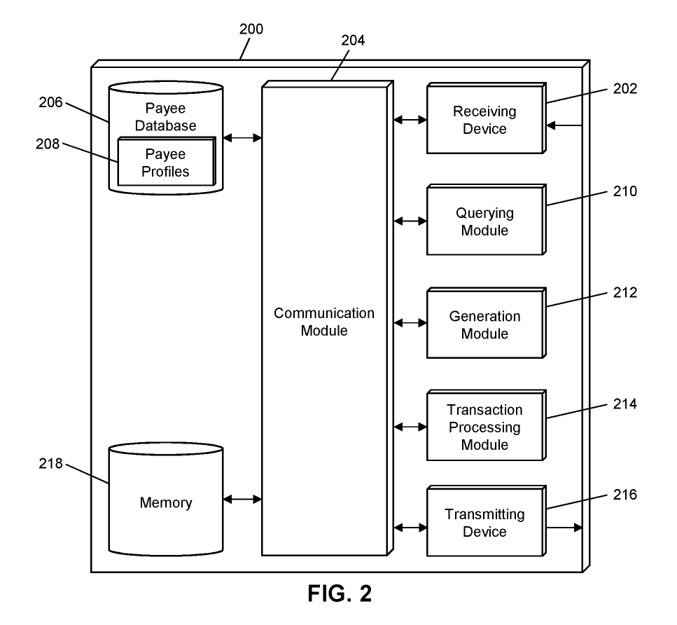

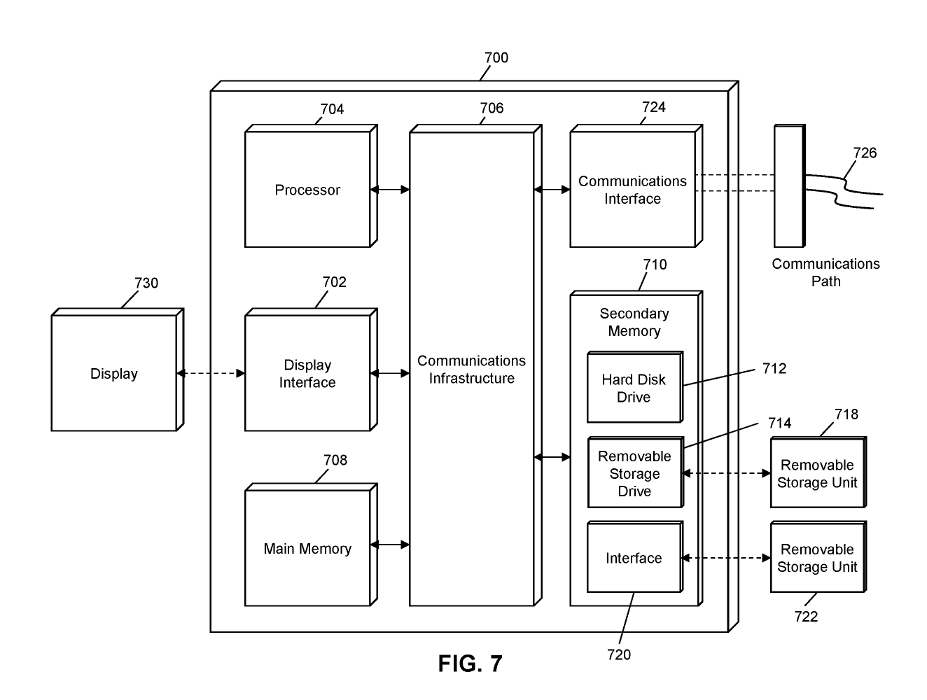

FIG. 2 illustrates an embodiment of a processing server 200 in the system 100. It will be apparent to persons having skill in the relevant art that the embodiment of the processing server 200 illustrated in FIG. 2 is provided as illustration only and may not be exhaustive to all possible configurations of the processing server 200 suitable for performing the functions as discussed herein. For example, the computer system 700 illustrated in FIG. 7 and discussed in more detail below may be a suitable configuration of the processing server 200. As discussed herein, the processing server 200 may be included as part of or may comprise the first merchant system 102 or intermediary system 112, as applicable, such as may be dependent on the implementation of the system 100.

The processing server 200 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 110 for the transmission of transaction messages that include sensitive financial data and information. In some instances, the receiving device 202 may also be configured to receive data from first merchant systems 102, computing devices 102, intermediary systems 112, second merchant systems 114, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 108, which may be superimposed or otherwise encoded with payment credentials for use in payment transactions. The receiving device 202 may also receive data signals electronically transmitted by computing devices 108 that are superimposed or otherwise encoded with reference identifiers or other data associated with the acceptance of a secondary payment opportunity. The receiving device 202 may also be configured to receive data signals electronically transmitted by first merchant systems 102, which may be superimposed or otherwise encoded with secondary payment opportunity requests, which may include reference identifiers, transaction data, or other data. The receiving device 202 may also be configured to receive data signals electronically transmitted by intermediary systems 112 and/or secondary merchant systems 114, which may be superimposed or otherwise encoded with secondary payment opportunity data, such as transaction information, reference identifiers, etc.

The processing server 200 may also include a communication module 204. The communication module 204 may be configured to transmit data between modules, engines, databases, memories, and other components of the processing server 200 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 200 and external components of the processing server 200, such as externally connected databases, display devices, input devices, etc. The processing server 200 may also include a processing device. The processing device may be configured to perform the functions of the processing server 200 discussed herein as will be apparent to persons having skill in the relevant art. In some embodiments, the processing device may include and/or be comprised of a plurality of engines and/or modules specially configured to perform one or more functions of the processing device, such as a querying module 210, generation module 212, transaction processing module 214, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 200 may also include a payee database 206. The payee database 206 may be configured to store a plurality of payee profiles 208 using a suitable data storage format and schema. The payee database 206 may be a relational database that utilizes structured query language for the storage, identification, modifying, updating, accessing, etc. of structured data sets stored therein. Each payee profile 208 may be a structured data set configured to store data related to one or more payee institutions. Each payee profile 208 may include at least communication details and one or more selection criteria. The one or more selection criteria may be used to identify a payee profile 208 based on a correspondence between the criteria and transaction data for an initial payment transaction. For instance, the selection criteria may include a merchant category, product category, etc. The communication details may be used by the processing server 200 in communicating with the related entity, such as an internet protocol address, media access control address, etc.

The processing server 200 may include a querying module 210. The querying module 210 may be configured to execute queries on databases to identify information. The querying module 210 may receive one or more data values or query strings, and may execute a query string based thereon on an indicated database, such as the payee database 206, to identify information stored therein. The querying module 210 may then output the identified information to an appropriate engine or module of the processing server 200 as necessary. The querying module 210 may, for example, execute a query on the payee database 206 to identify one or more payee profiles 208 whose selection criteria correspond to transaction data included in a secondary payment opportunity request (e.g., received via the receiving device 202), for contacting of the related entities for identification of secondary payment opportunities.

The processing server 200 may also include a generation module 212. The generation module 212 may be configured to generate data signals and other data for use in performing the functions of the processing server 200 as discussed herein. The generation module 212 may receive an instruction, may generate data or a data signal based thereon, and may provide the generated data or data signal to another module or engine of the processing server 200. In some instances, the generation module 212 may receive data for inclusion in the data signals or used in the generation thereof as input. In other in instances, the generation module 212 may be configured to identify (e.g., via instruction to the querying module 210) data for usage. The generation module 212 may be configured to generate data signals for electronic transmission to the first merchant system 102, computing device 108, intermediary system 112, second merchant system 114, or payment network 110 for use in performing the functions of the processing server 200 discussed herein. In some embodiments, the generation module 212 may be configured to generate or otherwise identify reference identifiers.

The computing device 104 may also include a transaction processing module 214. The transaction processing module 214 may be configured to perform the functions of the processing server 200 as related to the processing of payment transactions as will be apparent to persons having skill in the relevant art. For instance, the transaction processing module 214 may be configured to generate transaction messages for payment transactions, which may be formatted pursuant to one or more standards, such as the ISO 8583 or ISO 20022 standards, and include a message type indicator and a plurality of data elements configured to store transaction data for the related payment transaction.

The processing server 200 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 110 for the transmission of transaction messages that include sensitive financial data and information, such as identified payment credentials. In some instances, the transmitting device 216 may be configured to transmit data to computing devices 108, first merchant systems 102, intermediary systems 112, second merchant systems 114, payment networks 110, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to computing devices 108 that are superimposed or otherwise encoded with secondary payment opportunity data, which may include transaction data, product data, reference identifiers, etc. The transmitting device 216 may also be configured to electronically transmit data signals to payment networks 110, which may be superimposed or otherwise encoded with transaction messages for payment transactions, including initial and/or secondary payment transactions. The transmitting device 216 may also be configured to electronically transmit data signals to intermediary systems 112 and/or second merchant systems 114, such as may be superimposed or otherwise encoded with secondary payment opportunity requests and/or payment credentials, which may include payment data, transaction data, reference identifiers, etc. The transmitting device 216 may also be configured to electronically transmit data signals to first merchant systems 102 that are superimposed or otherwise encoded with secondary payment opportunities for forwarding to computing devices 108.

The processing server 200 may also include a memory 218. The memory 218 may be configured to store data for use by the processing server 200 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 200 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### Process for Leveraging Authentication in Secondary Payment Transactions

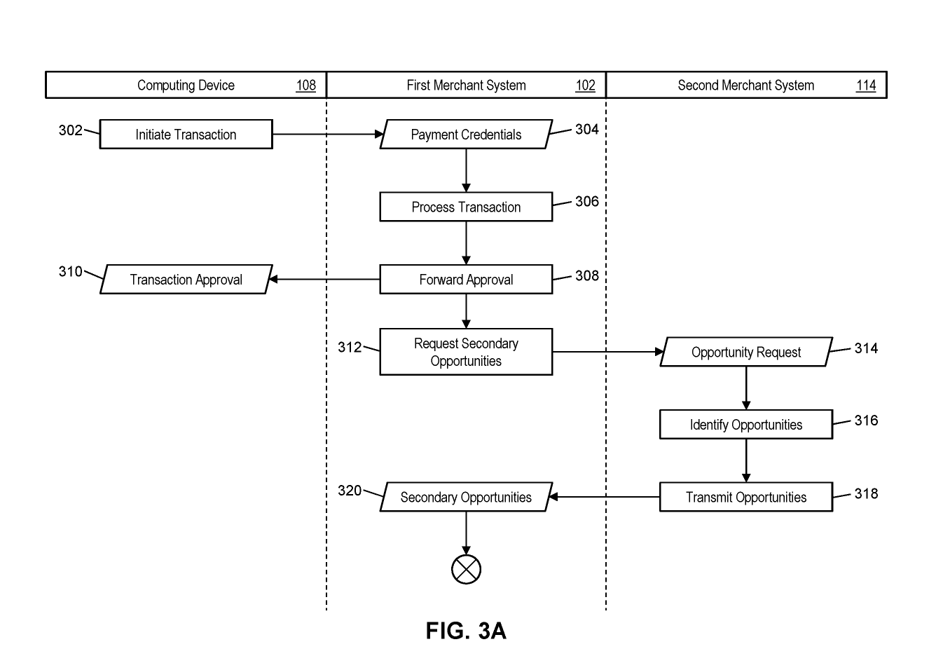

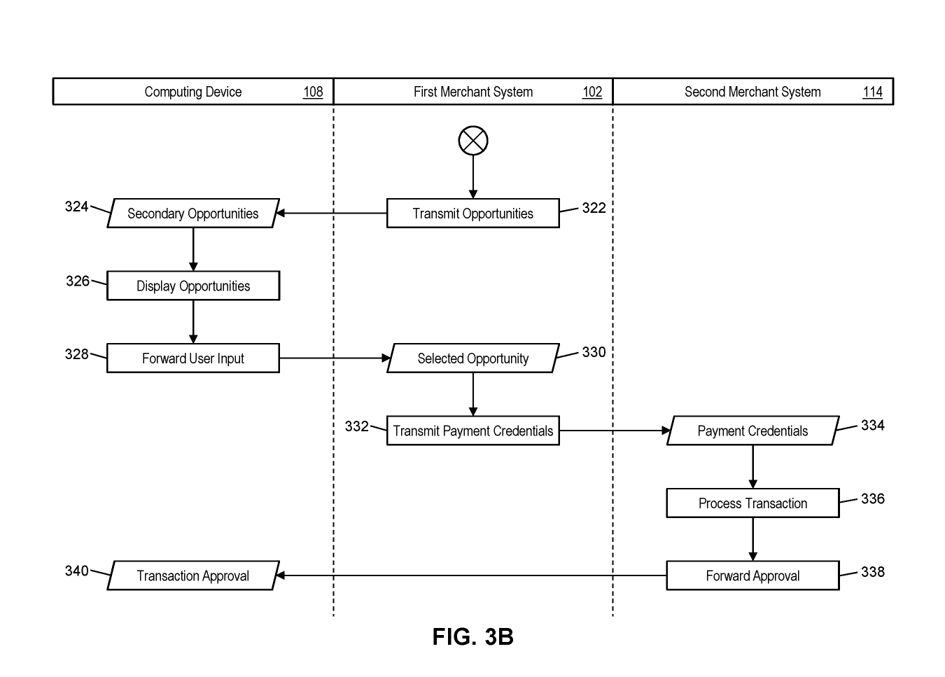

FIGS. 3A and 3B illustrate a process for the leveraging authenticated payment credentials in a secondary payment transaction using the system 100 including the first merchant system 102 and a second merchant system 114.

In step 302, the consumer 104 may use the computing device 108 to initiate a payment transaction with a first merchant system 102. The initiation of the payment transaction may include the submission of payment credentials using the computing device 108, which may be electronically transmitted to the first merchant system 102 by the computing device 108. In step 304, the receiving device 202 of the first merchant system 102 may receive the payment credentials and any other transaction data from the computing device 108 (e.g., and any intermediate entity, such as a web server). In step 306, the transaction processing module 214 of the first merchant system 102 may process the payment transaction, which may include the generation of a transaction message including the transaction data and payment credentials and electronic transmission (e.g., via the transmitting device 216) to the payment network 110. As part of the processing of the payment transaction, the receiving device 202 of the first merchant system 102 may receive an authorization response indicating approval of the payment transaction from the payment network 110.

In step 308, the transmitting device 216 of the first merchant system 102 may electronically transmit a notification to the computing device 108 that indicates approval of the payment transaction. In step 310, the computing device 108 may receive the approval. The approval may be, for example, a receipt, a transaction confirmation, etc. In step 312, the transmitting device 216 of the first merchant system 102 may electronically transmit a request for secondary payment opportunities to the second merchant system 114 using a suitable communication network and method. In some instances, the request may include a reference identifier, transaction data, consumer criteria, or other data used in the identification of secondary payment opportunities.

In step 314, the second merchant system 114 may receive the secondary payment opportunity request. In step 316, the second merchant system 114 may identify one or more secondary payment opportunities for the consumer 104. In some cases, the secondary payment opportunities may be identified based on transaction data or other criteria provided by the first merchant system 102. For example, the second merchant system 114 may identify secondary payment opportunities in the same industry or a related industry as the initial payment transaction. In another example, the secondary payment opportunities may be associated with preferences of the consumer 104, such as if the consumer 104 has specific interests. In step 318, the second merchant system 114 may electronically transmit a data signal back to the first merchant system 102 that is superimposed or otherwise associated with the identified secondary payment opportunity or opportunities.

In step 320, the receiving device 202 of the first merchant system 102 may receive the data for the secondary payment opportunities. In step 322, the transmitting device 216 of the first merchant system 102 may forward the secondary payment opportunities to the computing device 108 using a suitable communication network and method, such as via a dedicated application program or a web site hosted by an associated web server. In step 324, the computing device 108 may receive the secondary payment opportunities, and, in step 326, may display the secondary payment opportunities to the consumer 104 for selection. In step 328, the computing device 108 may receive a user input of a secondary payment opportunity for acceptance and may electronically transmit a data signal superimposed with data indicative thereof, such as a reference identifier, product selections, etc., to the first merchant system 102.

In step 330, the receiving device 202 of the first merchant system 102 may receive the information indicating the selected secondary payment opportunity. In step 332, the transmitting device 216 of the first merchant system 102 may electronically transmit a data signal superimposed or otherwise encoded with the user selection as well as the previously received payment credentials to the second merchant system 114. In step 334, the second merchant system 114 may receive the payment credentials and user selection. In step 336, the second merchant system 114 may initiate the second payment transaction based on the user selection, with the payment credentials being submitted for payment thereof. As part of the processing, the second merchant system 114 may receive an authorization response for the payment transaction indicating approval thereof. In step 338, the second merchant system 114 may electronically transmit a data signal to the computing device 108 that is superimposed or otherwise encoded with the indication of approval of the payment transaction. In step 340, the computing device 108 may receive (e.g., and display to the consumer 104) the approval of the secondary payment transaction.

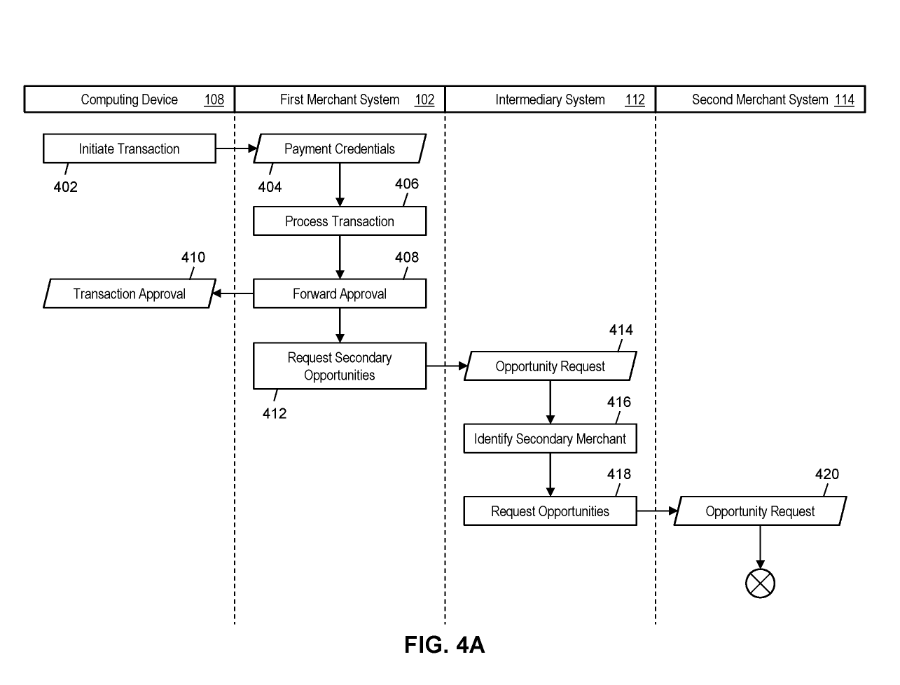

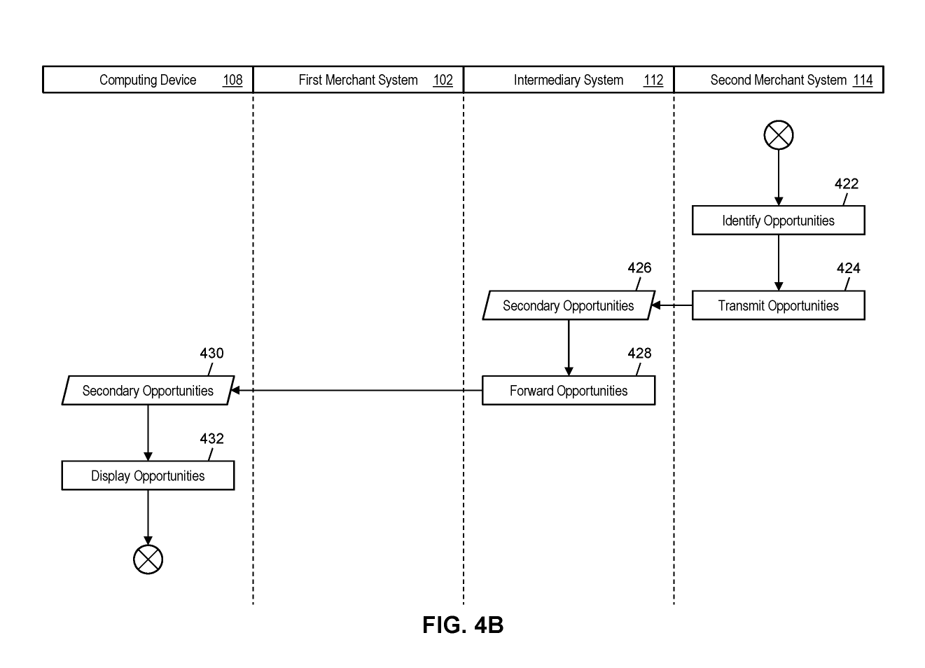

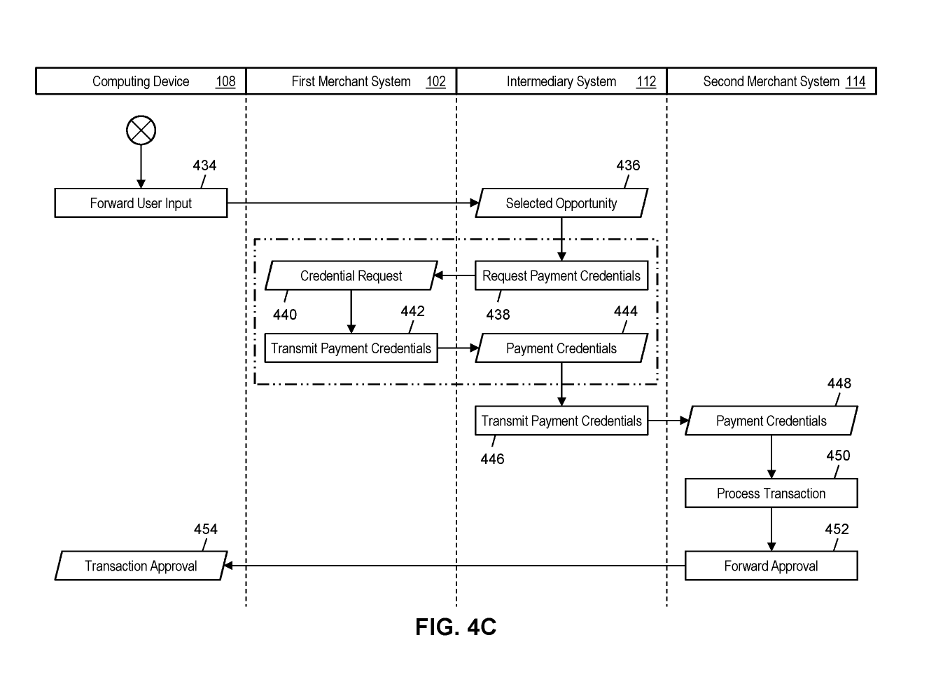

FIGS. 4A-4C illustrate a process for the leveraging authenticated payment credentials in a secondary payment transaction using the system 100 including an intermediary system 112.

In step 402, the consumer 104 may use the computing device 108 to initiate a payment transaction with a first merchant system 102. The initiation of the payment transaction may include the submission of payment credentials using the computing device 108, which may be electronically transmitted to the first merchant system 102 by the computing device 108. In step 404, the receiving device 202 of the first merchant system 102 may receive the payment credentials and any other transaction data from the computing device 108 (e.g., and any intermediate entity, such as a web server). In step 406, the transaction processing module 214 of the first merchant system 102 may process the payment transaction, which may include the generation of a transaction message including the transaction data and payment credentials and electronic transmission (e.g., via the transmitting device 216) to the payment network 110. As part of the processing of the payment transaction, the receiving device 202 of the first merchant system 102 may receive an authorization response indicating approval of the payment transaction from the payment network 110.

In step 408, the transmitting device 216 of the first merchant system 102 may electronically transmit a notification to the computing device 108 that indicates approval of the payment transaction. In step 410, the computing device 108 may receive the approval. The approval may be, for example, a receipt, a transaction confirmation, etc. In step 412, the transmitting device 216 of the first merchant system 102 may electronically transmit a request for secondary payment opportunities to the intermediary system 112 using a suitable communication network and method. In some instances, the request may include a reference identifier, transaction data, consumer criteria, or other data used in the identification of secondary payment opportunities.

In step 414, the receiving device 202 of the intermediary system 112 may receive the request for secondary payment opportunities. In step 416, the querying module 210 of the intermediary system 112 may execute a query on the payee database 206 to identify one or more payee profiles 208 based on the request, where the included one or more selection criteria corresponds to the transaction data for the payment transaction as indicated in the secondary payment opportunity request. In step 418, the transmitting device 216 of the intermediary system 112 may electronically transmit a request for secondary payment opportunities to each of the identified second merchant systems 114 via the communication details included in the respective identified payee profile 208. In some instances, the requests may include transaction data, consumer preferences, merchant preferences, or other criteria for use in identification of the opportunities.

In step 420, the second merchant systems 114 may receive the request from the intermediary system 112. In step 422, the second merchant system 114 may identify one or more secondary payment opportunities for the consumer 104. In some cases, the secondary payment opportunities may be identified based on transaction data or other criteria provided by the intermediary system 112. For example, the second merchant system 114 may identify secondary payment opportunities in the same industry or a related industry as the initial payment transaction. In another example, the secondary payment opportunities may be associated with preferences of the consumer 104, such as if the consumer 104 has specific interests. In step 424, the second merchant system 114 may electronically transmit a data signal back to the intermediary system 112 that is superimposed or otherwise associated with the identified secondary payment opportunity or opportunities.

In step 426, the receiving device 202 of the intermediary system 112 may receive the secondary payment opportunities from the second merchant systems 114 that provide them. In step 428, the transmitting device 216 of the intermediary system 112 may electronically transmit the secondary payment opportunities to the computing device 108. In some instances, the intermediary system 112 may filter the secondary payment opportunities prior to forwarding, such as based on filtering rules or criteria provided by the first merchant system 102. In step 430, the computing device 108 may receive the secondary payment opportunities, and, in step 432, may display the secondary payment opportunities to the consumer 104 for selection. In step 434, the computing device 108 may receive a user input of a secondary payment opportunity for acceptance and may electronically transmit a data signal superimposed with data indicative thereof, such as a reference identifier, product selections, etc., to the first merchant system 102.

In step 436, the receiving device 202 of the intermediary system 112 may receive the information indicating the selected secondary payment opportunity. In step 438, the transmitting device 216 of the intermediary system 112 may electronically transmit a data signal superimposed with a payment credential request to the first merchant system 102. In some instances, the request may include a reference identifier associated with the first payment transaction. In step 440, the receiving device 202 of the first merchant system 102 may receive the payment credential request. In step 442, the transmitting device 216 of the first merchant system 102 may electronically transmit the payment credentials provided for the first payment transaction to the intermediary system 112. In step 444, the receiving device 202 of the intermediary system 112 may receive the payment credentials. In some embodiments, steps 438-444 may be optional, such as in instances where the request for secondary payment opportunities (e.g., received in step 414) may include the payment credentials.

In step 446, the transmitting device 216 of the intermediary system 112 may electronically transmit a data signal to the second merchant system 114 associated with the accepted secondary payment opportunity that is superimposed or otherwise encoded with the payment credentials and any other data associated with the acceptance of the opportunity, such as shipping information, product selections, etc. In step 448, the second merchant system 114 may receive the payment credentials and user selection. In step 450, the second merchant system 114 may initiate the second payment transaction based on the user selection, with the payment credentials being submitted for payment thereof. As part of the processing, the second merchant system 114 may receive an authorization response for the payment transaction indicating approval thereof. In step 452, the second merchant system 114 may electronically transmit a data signal to the computing device 108 that is superimposed or otherwise encoded with the indication of approval of the payment transaction. In step 454, the computing device 108 may receive (e.g., and display to the consumer 104) the approval of the secondary payment transaction.

### Exemplary Method for Supplying Payment Credentials in a Secondary Payment Opportunity

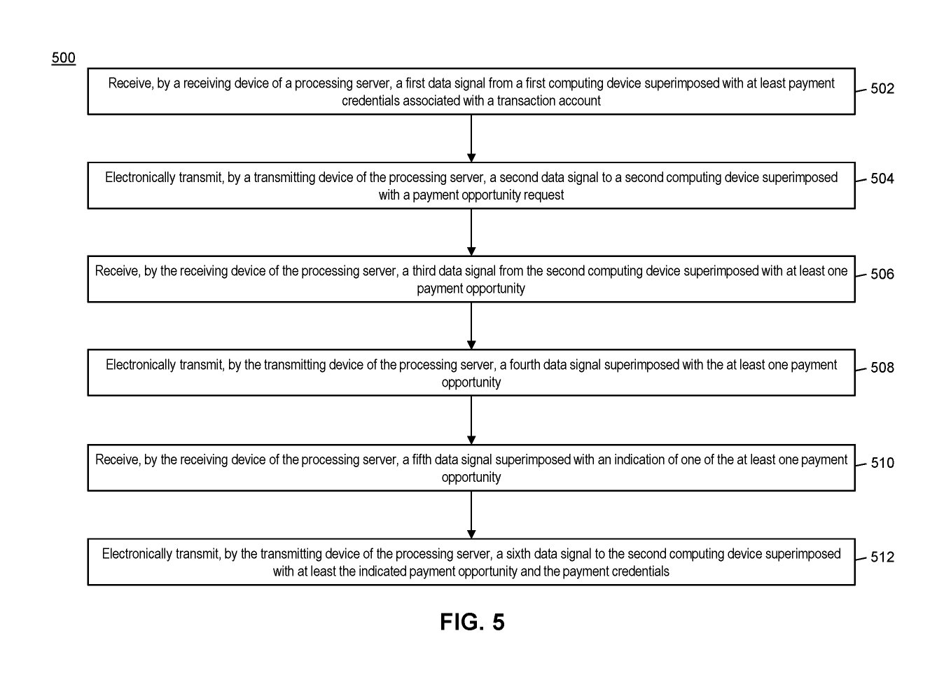

FIG. 5 illustrates a method 500 for the leveraging of authenticated payment credentials for a processed payment transaction in a secondary payment opportunity for use thereof.

In step 502, a first data signal may be received by a receiving device (e.g., the receiving device 202) of a processing server (e.g., the processing server 200) from a first computing device (e.g., the computing device 108 or first merchant system 102) superimposed with at least payment credentials associated with a transaction account. In step 504, a second data signal may be electronically transmitted by a transmitting device (e.g., the transmitting device 216) of the processing server to a second computing device (e.g., the intermediary system 112 or second merchant system 114) superimposed with a payment opportunity request. In step 506, a third data signal may be received by the receiving device of the processing server from the second computing device that is superimposed with at least one payment opportunity.

In step 508, a fourth data signal may be electronically transmitted by the transmitting device of the processing server superimposed with the at least one payment opportunity. In step 510, a fifth data signal superimposed with an indication of the at least one payment opportunity may be received by the receiving device of the processing server. In step 512, a sixth data signal may be electronically transmitted by the transmitting device of the processing server to the second computing device that is superimposed with at least the indicated payment opportunity and the payment credentials.

In one embodiment, the payment opportunity request may include the payment credentials. In some embodiments, the method 500 may further include generating, by a data generation module (e.g., the generation module 212) of the processing server, a reference identifier associated with the payment credentials, wherein the payment opportunity request includes the reference identifier. In one embodiment, the payment opportunity request may include transaction data associated with a first payment transaction involving the first computing device. In some embodiments, the payment credentials may be used by the second computing device in a second payment transaction associated with the indicated payment opportunity.

In one embodiment, the method 500 may also include electronically transmitting, by the transmitting device of the processing server, at least the payment credentials and transaction data to a financial institution for use in a first payment transaction. In some embodiments, the payment credentials may comprise a reference identifier associated with a transaction account number, and the method 500 may further include: electronically transmitting, by the transmitting device of the processing server, a sixth data signal to the first computing device superimposed with at least a number request; and receiving, by the receiving device of the processing server, a seventh data signal from the first computing device superimposed with at least the transaction account number associated with the payment credentials, wherein the sixth data signal is further superimposed with the transaction account number.

In one embodiment, the fourth data signal may be electronically transmitted to the first computing device, and the fifth data signal may be received from the first computing device. In some embodiments, the fourth data signal may be electronically transmitted to a third computing device associated with the transaction account, and the fifth data signal may be received from the third computing device. In one embodiment, the method 500 may also include: storing, in a payee database (e.g., the payee database 206) of the processing server, a plurality of payee profiles (e.g., payee profiles 208), wherein each payee profile includes a structured data set related to a payee institution including at least communication details and one or more selection criteria; and executing, by a querying module (e.g., the querying module 210) of the processing server, a query on the payee database to identify a specific payee profile based on a correspondence between the included one or more selection criteria and transaction data, wherein the first data signal is further superimposed with the transaction data, and the second computing device is associated with the communication details included in the specific payee profile.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the first merchant system 102, consumer 104, issuer system 106, computing device 108, payment network 110, intermediary system 112, second merchant system 114, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3A, 3B, 4A-4C, and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the first merchant system 102 or intermediary system 112 of FIG. 1 or the processing server 200 of FIG. 2 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 4A-4C, 5, and 6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3A, 3B, 4A-4C, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for supplying payment credentials in a secondary payment opportunity. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for supplying payment credentials in a secondary payment opportunity, comprising:
receiving, by a receiving device of a processing server, a first data signal from a first computing device superimposed with at least payment credentials associated with a transaction account;
electronically transmitting, by a transmitting device of the processing server, a second data signal to a second computing device superimposed with a payment opportunity request;
receiving, by the receiving device of the processing server, a third data signal from the second computing device superimposed with at least one payment opportunity;
electronically transmitting, by the transmitting device of the processing server, a fourth data signal superimposed with the at least one payment opportunity;
receiving, by the receiving device of the processing server, a fifth data signal superimposed with an indication of one of the at least one payment opportunity; and
electronically transmitting, by the transmitting device of the processing server, a sixth data signal to the second computing device superimposed with at least the indicated payment opportunity and the payment credentials.

2. The method of claim 1, wherein the payment opportunity request includes the payment credentials.

3. The method of claim 1, further comprising:
generating, by a data generation module of the processing server, a reference identifier associated with the payment credentials, wherein
the payment opportunity request includes the reference identifier.

4. The method of claim 1, wherein the payment opportunity request includes transaction data associated with a first payment transaction involving the first computing device.

5. The method of claim 1, wherein the payment credentials are used by the second computing device in a second payment transaction associated with the indicated payment opportunity.

6. The method of claim 1, further comprising:
electronically transmitting, by the transmitting device of the processing server, at least the payment credentials and transaction data to a financial institution for use in a first payment transaction.

7. The method of claim 1, wherein the payment credentials comprise a reference identifier associated with a transaction account number, and the method further comprises:
electronically transmitting, by the transmitting device of the processing server, a sixth data signal to the first computing device superimposed with at least a number request; and
receiving, by the receiving device of the processing server, a seventh data signal from the first computing device superimposed with at least the transaction account number associated with the payment credentials, wherein
the sixth data signal is further superimposed with the transaction account number.

8. The method of claim 1, wherein
the fourth data signal is electronically transmitted to the first computing device, and
the fifth data signal is received from the first computing device.

9. The method of claim 1, wherein
the fourth data signal is electronically transmitted to a third computing device associated with the transaction account, and
the fifth data signal is received from the third computing device.

10. The method of claim 1, further comprising:
storing, in a payee database of the processing server, a plurality of payee profiles, wherein each payee profile includes a structured data set related to a payee institution including at least communication details and one or more selection criteria; and
executing, by a querying module of the processing server, a query on the payee database to identify a specific payee profile based on a correspondence between the included one or more selection criteria and transaction data, wherein
the first data signal is further superimposed with the transaction data, and
the second computing device is associated with the communication details included in the specific payee profile.

11. A system for supplying payment credentials in a secondary payment opportunity, comprising:
a receiving device of a processing server configured to receive a first data signal from a first computing device superimposed with at least payment credentials associated with a transaction account; and
a transmitting device of the processing server configured to electronically transmit a second data signal to a second computing device superimposed with a payment opportunity request, wherein
the receiving device of the processing server is further configured to receive a third data signal from the second computing device superimposed with at least one payment opportunity,
the transmitting device of the processing server is further configured to electronically transmit a fourth data signal superimposed with the at least one payment opportunity,
the receiving device of the processing server is further configured to receive a fifth data signal superimposed with an indication of one of the at least one payment opportunity, and
the transmitting device of the processing server is further configured to electronically transmit a sixth data signal to the second computing device superimposed with at least the indicated payment opportunity and the payment credentials.

12. The system of claim 11, wherein the payment opportunity request includes the payment credentials.

13. The system of claim 11, further comprising:
a data generation module of the processing server configured to generate a reference identifier associated with the payment credentials, wherein
the payment opportunity request includes the reference identifier.

14. The system of claim 11, wherein the payment opportunity request includes transaction data associated with a first payment transaction involving the first computing device.

15. The system of claim 11, wherein the payment credentials are used by the second computing device in a second payment transaction associated with the indicated payment opportunity.

16. The system of claim 11, wherein the transmitting device of the processing server is further configured to electronically transmit at least the payment credentials and transaction data to a financial institution for use in a first payment transaction.

17. The system of claim 11, wherein
the payment credentials comprise a reference identifier associated with a transaction account number
the transmitting device of the processing server is further configured to electronically transmit a sixth data signal to the first computing device superimposed with at least a number request,
the receiving device of the processing server is further configured to receive a seventh data signal from the first computing device superimposed with at least the transaction account number associated with the payment credentials, and
the sixth data signal is further superimposed with the transaction account number.

18. The system of claim 11, wherein
the fourth data signal is electronically transmitted to the first computing device, and
the fifth data signal is received from the first computing device.

19. The system of claim 11, wherein
the fourth data signal is electronically transmitted to a third computing device associated with the transaction account, and
the fifth data signal is received from the third computing device.

20. The system of claim 11, further comprising:
a payee database of the processing server configured to store a plurality of payee profiles, wherein each payee profile includes a structured data set related to a payee institution including at least communication details and one or more selection criteria; and
a querying module of the processing server configured to execute a query on the payee database to identify a specific payee profile based on a correspondence between the included one or more selection criteria and transaction data, wherein
the first data signal is further superimposed with the transaction data, and
the second computing device is associated with the communication details included in the specific payee profile.
